(19) United States
(12) Patent Application Publication
(10) Pub. No.: US 2009/0272609 A1
(43) Pub. Date: Nov. 5, 2009

(54) Venturi Nozzle Aerodynamic Vent Design

(76) Inventors: Raju (nmn) Karthik, Farmington Hills, MI (US); Mauricio Gonzalez-Rocha, Novi, MI (US)

Correspondence Address: Benita J Rohm;Rohm & Monsanto, 12 Rathbone Place, Grosse Pointe, MI, 48230, US

(21) Appl. No.: 12/226,087

(22) PCT Filed: Apr. 5, 2007
(86) PCT No.: PCT/US07/08615

§ 371 Date: Dec. 15, 2008

Related U.S. Application Data
(60) Provisional application No. 60/789,981, filed on Apr. 5, 2006.

(51) Int. Cl. F16D 65/00

(52) U.S. Cl. 188/264 AA

(57) ABSTRACT

A rotor arrangement for the brake system of a vehicle has first and second annular rotor plates substantially in parallel, with a ventilated region therebetween for cooling the rotor plates. A plurality of airfoil-shaped structures is arranged in the ventilated region, each being coupled at one portion thereof to the first rotor plate, and at a second portion thereof to the second rotor plate, to maintain the first and second rotor plates in fixed spatial relation. The first and second rotor plates and the airfoil-shaped pillar structures are integrally formed, the interior surfaces of the rotor plates being configured as an annular venturi that increases the air flow therebetween. The airfoil-shaped structures are configured as airfoil-shaped pillars and fins to form a corresponding plurality of effective venturi nozzles whereby the flow of air between the rotor plates is laminar and increased to enhance the cooling of the annular rotor plates.

### BACKGROUND OF THE INVENTION

1. Field of the Invention

This invention relates generally to braking systems for vehicles, and more particularly, to a disc brake rotor having an aerodynamic vent that improves rotor ventilation while achieving ease of manufacture.

2. Description of the Related Art

It is well known that a large amount of heat is produced during the stopping of a vehicle. The heat results from the conversion of kinetic energy, and most of this heat is conducted into the brake rotor, where multiple adverse conditions are thereby generated. These include, for example, the distortion of the rotor face plates and a diminution in friction between the brake caliper pads and the brake rotor.

It is, therefore, an object of this invention to provide a brake rotor arrangement wherein heat is rapidly removed.

It is another object of this invention to provide a ventilated brake rotor arrangement that rapidly transfers heat away from the rotor face plates.

It is also an object of this invention to provide a ventilated brake rotor arrangement that enhances heat removal by increasing a laminar characteristic of the ventilation airflow.

It is a further object of this invention to provide a ventilated brake rotor arrangement that enhances heat removal without requiring a significant increase in the mass of the rotor.

### SUMMARY OF THE INVENTION

The foregoing and other objects are achieved by this invention which provides a rotor arrangement for the brake system of a vehicle. The rotor arrangement is provided with first and second rotor plates that are arranged substantially in parallel to one another. A ventilated region for cooling the rotor plates is disposed therebetween. There is additionally provided an airfoil-shaped structure arranged in the ventilated region.

In a highly advantageous embodiment of the invention, the first and second rotor plates have an annular central region therebetween that has a reduced axial distance to create an annular venturi effect in a substantially radial airflow.

In one embodiment of the invention, the airfoil-shaped structure is coupled at one portion thereof to the first rotor plate, and at a second portion thereof to the second rotor plate. The airfoil-shaped structure is provided with a structural element that maintains the first and second rotor plates in fixed spatial relation. Preferably, the first and second rotor plates and the airfoil-shaped structure are integrally formed.

In a highly advantageous embodiment of the invention, the airfoil-shaped structure is configured as an airfoil-shaped pillar. A plurality of airfoil-shaped pillars arranged in an annular row of airfoil-shaped pillars, and advantageously in a plurality of such rows. As such, the vent configuration forms a corresponding plurality of effective venturi nozzles. In accordance with a further aspect of the invention, there is further provided a plurality of airfoil-shaped fins arranged intermediate of the plurality of rows of airfoil-shaped pillars. In certain embodiments, the airfoil-shaped fins cooperate with the rotor plates to produce a plurality of effective venturi nozzles that enhance the rate of airflow between the rotor plates and the consequent removal of heat therefrom. However, a further venturi effect is obtained along the annulus of the rotor to enhance the airflow therethrough. More specifically, the interior surfaces of the brake plates bulge slightly inward toward each other to form an annular venturi nozzle that enhances the flow of air between the brake plates.

In a preferred embodiment, the airfoil-shaped structure is configured as an airfoil-shaped fin, and the first and second rotor plates are cross-sectionally configured in combination with the airfoil-shaped structure to produce an effective venturi nozzle.

In accordance with a further aspect of the invention, there is provided a rotor arrangement for the brake system of a vehicle, the rotor arrangement having first and second rotor plates arranged substantially in parallel, with a ventilated region therebetween, the first and second rotor plates having an annular central region therebetween that has a reduced axial distance to create an annular venturi effect in a radial airflow.

There is additionally provided in this further aspect of the invention an aerodynamic structure arranged in the ventilated region.

In a highly advantageous embodiment, there is further provided a plurality of aerodynamic structures arranged in the ventilated region, the aerodynamic structures being configured in relation to one another to produce regions therebetween that produce a venturi effect in the radial airflow.

In a still further apparatus aspect of the invention, there is provided a brake disk rotor arrangement for the brake system of a vehicle, the brake disk rotor arrangement having an annular configuration and a radius. In accordance with the invention, the brake disk rotor arrangement is provided with first and second brake disk rotor plates arranged substantially in parallel, with an annular ventilated region therebetween. The annular ventilated region has a variably configured axial distance so as to create an annular venturi that affects radial airflow. A plurality of airfoil-shaped structures arranged in the annular ventilated region.

In one embodiment of this further apparatus aspect of the invention, the plurality of airfoil-shaped structures each have a substantially elongated configuration that is radially aligned with the first and second brake disk rotor plates. The plurality of airfoil-shaped structures are arranged, in some embodiments, in annular rows of airfoil-shaped structures.

### BRIEF DESCRIPTION OF THE DRAWING

Comprehension of the invention is facilitated by reading the following detailed description, in conjunction with the annexed drawing, in which:

FIG. 1 is a simplified schematic cross-sectional representation of a disc brake rotor arrangement configured in the characteristic of a venturi nozzle in accordance with the principles of the invention;

FIG. 2 is a simplified schematic cross-sectional representation of an inverted hat disc brake rotor arrangement configured in the characteristic of a venturi nozzle in accordance with the principles of the invention;

FIG. 3 is a simplified schematic representation of an airfoil-shaped fin that is shaped in accordance with a specific illustrative embodiment of the invention;

FIG. 4 is a simplified schematic representation of an airfoil-shaped pillar shape that is useful in a specific illustrative embodiment of the invention;

FIG. 5 is a simplified schematic representation of an arrangement of airfoil-shaped pillars arranged in accordance with the principles of the invention;

FIGS. 6(a) and 6(b) are respective representations of the airflow in the ventilated region of a disc brake constructed in accordance with the principles of the invention;

FIG. 7 is a graphical representation that illustrates a comparison between a brake rotor constructed in accordance with the invention, and a baseline rotor;

FIG. 8 is a graphical representation that is useful to illustrate the air velocity effect achieved with a conventional inverted hat rotor design having a conventional pillar design; as compared to a conventional inverted hat with conventional pillars with venturi nozzles, and as further compared to the conventional inverted hat with the inventive airfoil-shaped pillars (denominated “e358” in this specific illustrative embodiment of the invention) and a venturi nozzle, within the vented region of a brake disk rotor;

FIG. 9 is a graphical representation that is useful to illustrate the mass flow rate of the air flowing through the vents, the mass flow rate being an indicator of the air discharge and shows the amount of air being transferred through the same area, the higher the better, this figure serving to compare the configurations of a conventional inverted hat with conventional pillar design; a conventional inverted hat with conventional pillars with venturi nozzles, and the conventional inverted hat with the inventive airfoil-shaped pillars and a venturi nozzle;

FIG. 10 is a graphical representation that is useful to illustrate essentially the same information as the heat transfer coefficient graph of FIG. 11, below;

FIG. 11 is a graphical representation that is useful to illustrate the comparison for the heat transfer coefficient, which is the most important characteristic, since it determines the convective cooling capacity of the rotor, the figure showing a comparison between the configurations of a conventional inverted hat with conventional pillar design; a conventional inverted hat with conventional pillars with venturi nozzles, and the conventional inverted hat with airfoil-shaped pillars and a venturi nozzle; and

FIGS. 12a, 12b, and 12b are illustrations that are useful in describing the flow of air within the core of a rotor having airfoil-shaped pillars in accordance with the invention and a core of a rotor having conventional diamond-shaped pillars.

### DETAILED DESCRIPTION

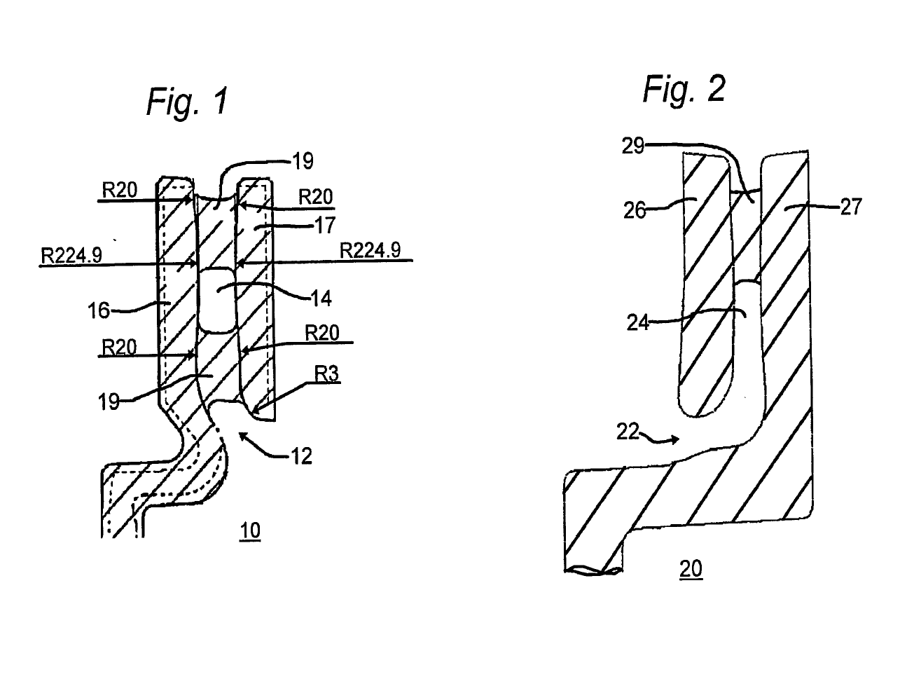

FIG. 1 is a simplified schematic cross-sectional representation of a disc brake rotor arrangement 10 configured in the characteristic of a venturi nozzle 12 in accordance with the principles of the invention. As shown in this figure, nozzle 12 is arranged at the inlet to ventilated area 14 to create pressure differentials (not shown in this figure) and thereby move air (not shown in this figure) faster. In this manner, an increased amount of air is essentially pumped into ventilated area 14. Ventilated area 14 is shown to be disposed between rotor face plates 16 and 17. More specifically, the interior surfaces of rotor face plates 16 and 17 are, in this specific illustrative embodiment of the invention, both axially inwardly arched with a predetermined curvature whereby the central annular region of ventilated area 14 has a reduced cross-sectional distance relative to the radially inward and outer peripheries. This creates an annular venturi nozzle effect for air that enters the ventilated area in the radial direction of arrows 15. As shown in this figure, the interior surfaces of rotor face plates 16 and 17 are each curved at a radius of 224.9″ in this specific illustrative embodiment of the invention.

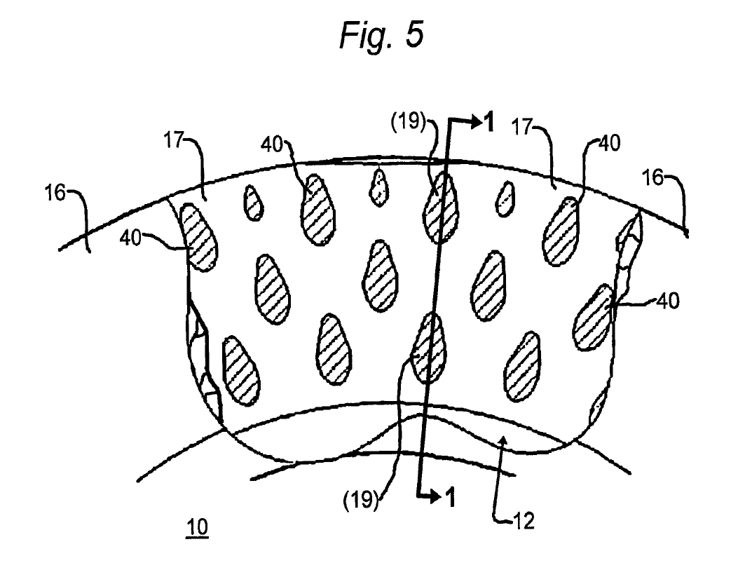

In this embodiment, disc brake rotor arrangement 10 is formed as a casting. The radii and other dimensions for the inlet nozzle are based on the castability and machinability of the rotor, and may be specific to the design constraints of each rotor application. Ventilated area 14 contains therewithin a plurality of structural supports 19 that are formed, as will be described below, as pillars or straight fins. In this specific representation of the invention, structural supports 19 are pillars, illustratively airfoil-shaped pillars 40 described in detail below in connection with FIGS. 4 and 5. FIG. 1 is a representation of the cross-section represented by section line 1-1 in FIG. 5

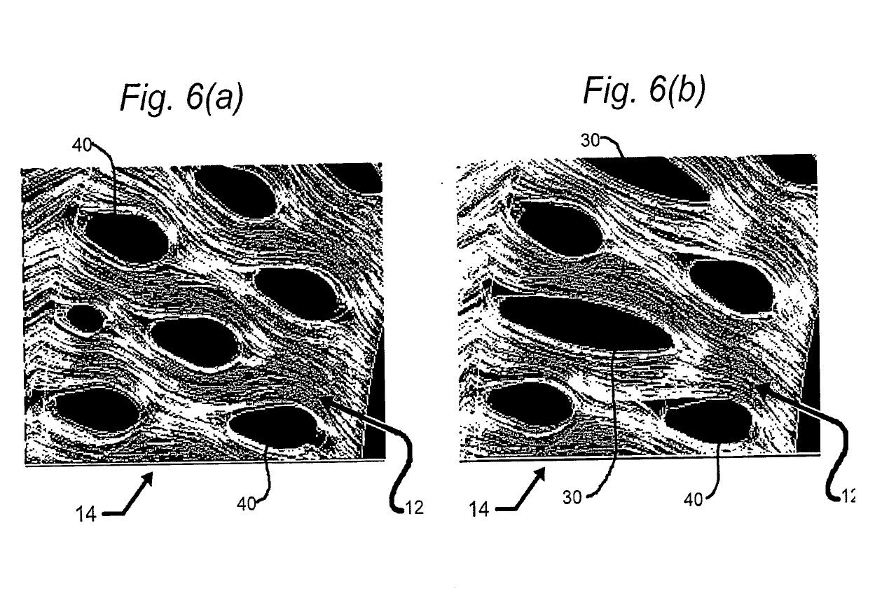

The pillars and straight fins help to optimize the overall vent cooling surface area (not specifically designated) and add structural strength between the rotor face plates, while providing a pathway for streamlined air flow (FIGS. 6(a) and 6(b)). The numbers of airfoil-shaped fins and pillars are determined in response to the rotor size and the geometry of the arrangement. In certain embodiments of the invention, there are provided between 20 to 40 sets of airfoil-shaped pillars distributed between rotor face plates 16 and 17. In a specific illustrative embodiment of the invention, each pillar set may consist of 2 to 4 annular rows of pillars arranged as will be described below in connection with FIG. 5.

FIG. 2 is a simplified schematic cross-sectional representation of an inverted hat disc brake rotor arrangement 20 configured in the characteristic of a venturi nozzle 22 in accordance with the principles of the invention. As shown in this figure, nozzle 22 is arranged at the inlet to ventilated area 24 to create pressure differentials (not shown in this figure) and thereby move air (not shown in this figure) faster. In this manner, an increased amount of air is essentially pumped into ventilated area 24. Ventilated area 24 is shown to be disposed between rotor face plates 26 and 27.

As discussed above in connection with FIG. 1, the interior surfaces of rotor face plates 26 and 27 are, in this specific illustrative embodiment of the invention, both axially inwardly arched with a predetermined curvature whereby the central annular region of ventilated area 24 has a reduced cross-sectional distance relative to the radially inward and outer peripheries. This creates an annular venturi nozzle effect for air that enters the ventilated area in the radial direction of arrows 15.

In this embodiment, inverted hat disc brake rotor arrangement 20 contains between rotor face plates 26 and 27 a plurality of structural supports 29, only one of which is shown in this figure, that are formed, as will be described below, as pillars or straight fins. The construction of the structural supports is based on rotor casting design constraints, and the structural supports are configured, will be discussed below, to improve the venting of the cooling surface area between rotor face plates 26 and 27 and to add structural strength therebetween. Also as will be discussed below, structural supports 29 provides a pathway (not shown in this figure) for effecting a streamlined air flow within the ventilated area.

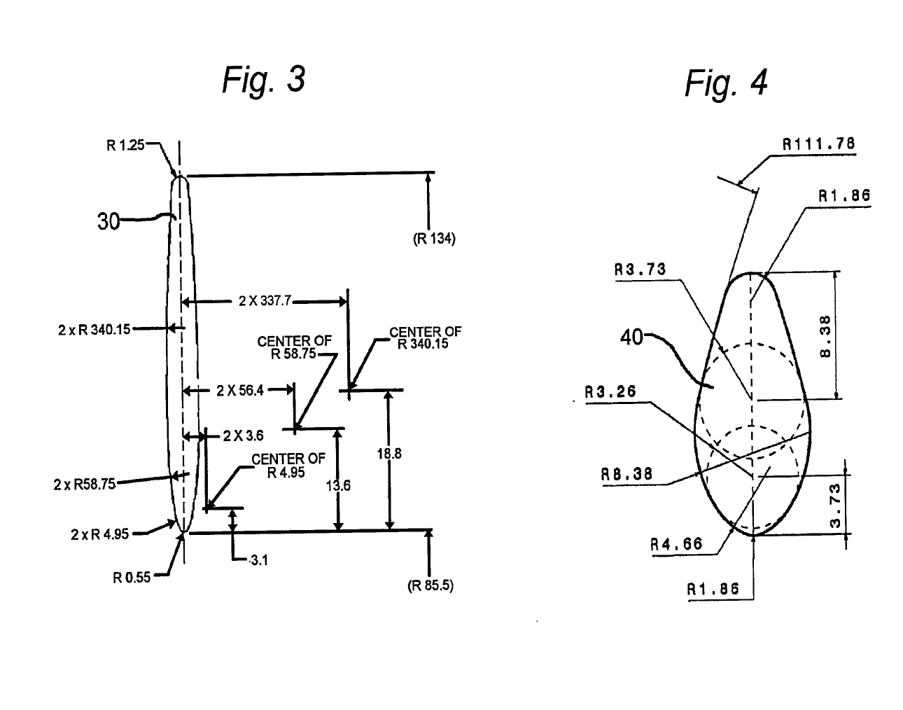

FIG. 3 is a simplified schematic representation of an airfoil-shaped fin 30 that is shaped in accordance with a specific illustrative embodiment of the invention. The airfoil-shaped fin is arranged to be disposed between the rotor face plates of the embodiments of FIGS. 1 and 2. In preferred embodiments of the invention, airfoil-shaped fin 30 is formed integrally with the rotor face plates.

FIG. 4 is a simplified schematic representation of an airfoil-shaped pillar 40, the shape of which being configured in accordance with a specific illustrative embodiment of the invention. The airfoil-shaped pillar is arranged to be disposed between the rotor face plates of the embodiments of FIGS. 1 and 2. In preferred embodiments of the invention, airfoil-shaped pillar 40 is formed integrally with the rotor face plates.

FIG. 5 is a simplified schematic representation of an arrangement of airfoil-shaped pillars 40 arranged in accordance with the principles of the invention. Elements of structure and designations that have previously been discussed are similarly identified. The cross-section represented by section line 1-1 is shown in FIG. 1. As shown in FIG. 5, airfoil-shaped pillar 40, which also function as support structures 19 (FIG. 1), are arranged as two to four annular rows of pillars. Airfoil-shaped pillars 40, and airfoil-shaped fins 30, which are not shown in this figure, are designed using the modified airfoil-shaped design of FIGS. 3 and 4. As previously noted, they are configured to provide an increased area of surface contact with the air in the vents, and prevent flow separation. The combined effect of the nozzles and the airfoil-shaped pillars in the core help to channel the air and maintain the laminar flow pattern around the pillars/fins, and reduce/prevent flow separation in the vent passage, as shown in FIGS. 6(a) and 6(b). The nozzles created between the airfoil-shaped pillars in the core cooperate with the venturi effect created by the inwardly arched interior surfaces of the rotor plates, as described hereinabove in connection with FIGS. 1 and 2.

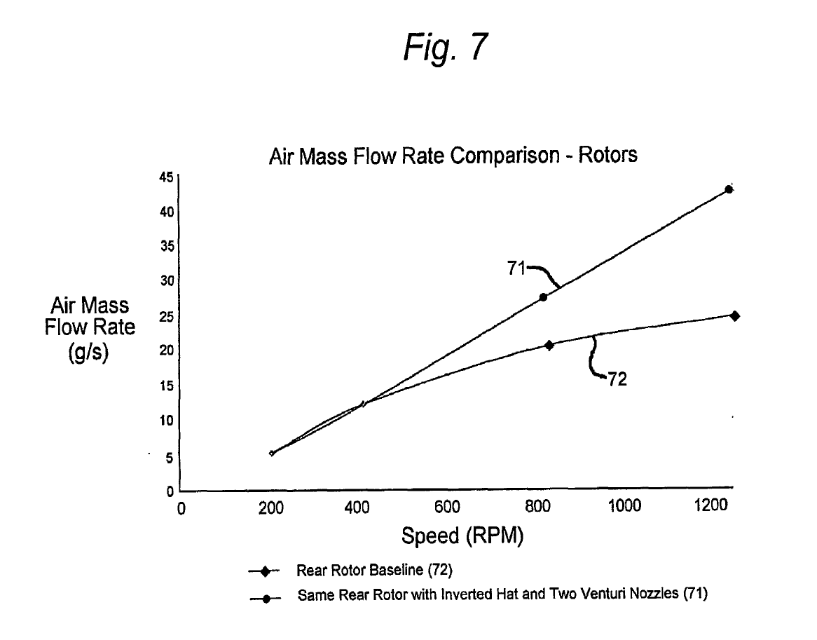

FIGS. 6(a) and 6(b) are respective representations of the airflow in the ventilated region of a disc brake constructed in accordance with the principles of the invention. Elements of structure and designations that have previously been discussed are similarly identified. Airfoil-shaped fins 30 and airfoil-shaped pillars 40 are designed using the airfoil-shaped designs of FIGS. 3 and 4, created to provide an increased area of surface contact with the air in the vents, and prevent flow separation. The nozzle contour and the airfoil-shaped pillars can be manufactured using sand castings with iron or iron composites or Aluminum composites or permanent molds with Aluminum or Aluminum composites. The combined effect of the nozzles and the airfoil-shaped pillars and airfoil-shaped fins in the ventilated area is to maintain a laminar flow pattern around the airfoil-shaped pillars and fins, and to reduce flow separation in the vent passage. These elements of structure also improve the air mass flow rate and the heat transfer coefficient in the ventilated area. The air, which is represented by the striations in the figures. enters ventilated area 14 via venturi nozzle 12. The effect of the venturi nozzle design in improving the air mass flow rate is shown in FIG. 7.

FIG. 7 is a graphical representation that illustrates a comparison between the air mass flow rate achieved by a rear brake rotor 71 having two venturi nozzles in accordance with the invention, and that achieved by a baseline rear rotor 72. As shown, the brake rotor of the present invention exhibits significantly improved air mass transfer in relation to rotor speed, over the baseline rotor.

The present invention affords improved air flow characteristics. More specifically, less flow separation and a more streamlined flow is achieved as a result of the use of venturi nozzles and aerodynamically configured pillars and fins that are, in accordance with the invention, design to have airfoil shapes. This results in cooler brake surface temperatures. Additionally, the higher mass flow rate and heat transfer coefficients that are achieved by the invention result in improved convective cooling of the rotor. An advantageous characteristic of the invention is a reduced propensity for brake torque variation that would result from the transient thermal deformation of the brake plates. Thus, improved wear characteristics are achieved due to the reduced brake surface temperatures.

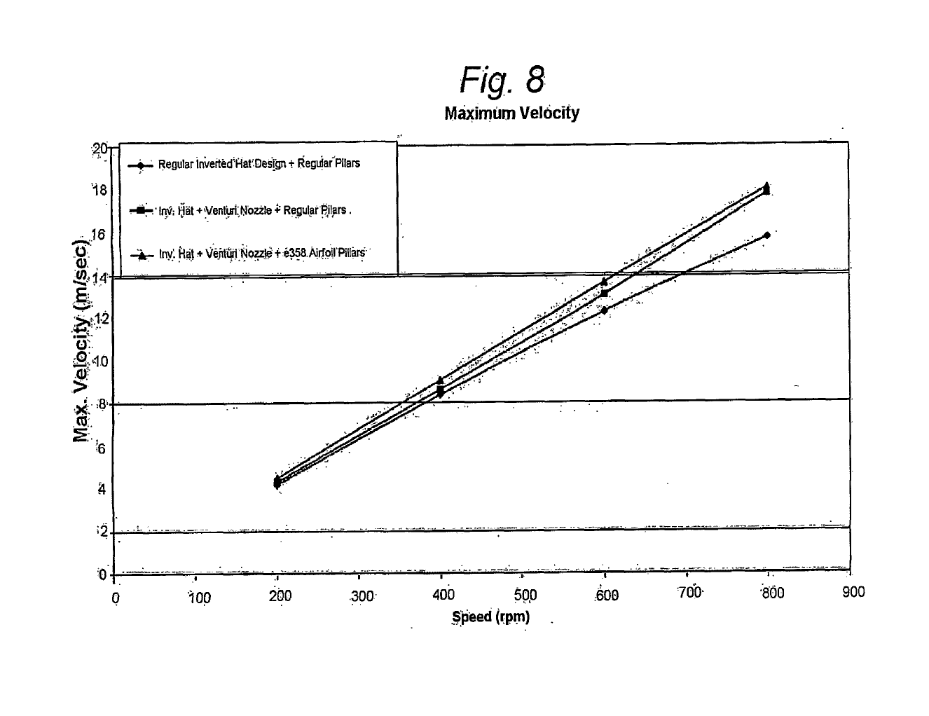

FIG. 8 is a graphical representation that is useful to illustrate the effect of the conventional inverted hat brake disk rotor having a conventional pillar design; conventional inverted hat brake disk rotor with conventional pillars with venturi nozzles, and the conventional inverted hat brake disk rotor with airfoil-shaped pillars and a venturi nozzle on the maximum air velocity within the vented region of the brake disk rotor. The figure shows that with the venturi nozzle and the airfoil-shaped pillars, faster movement of air through the vents is achieved.

As seen in the graph of FIG. 8 and the following figures, the beneficial effect of the present invention is more pronounced at higher speeds and the nozzles and air foil configurations offer significantly improved performance. The rotational speeds represented in units of “rpm” correspond to the following in units “mph” in a traveling vehicle (not shown):
200 rpm≈18 mph;
400 rpm≈36 mph;
600 rpm≈54 mph;
800 rpm≈72 mph.

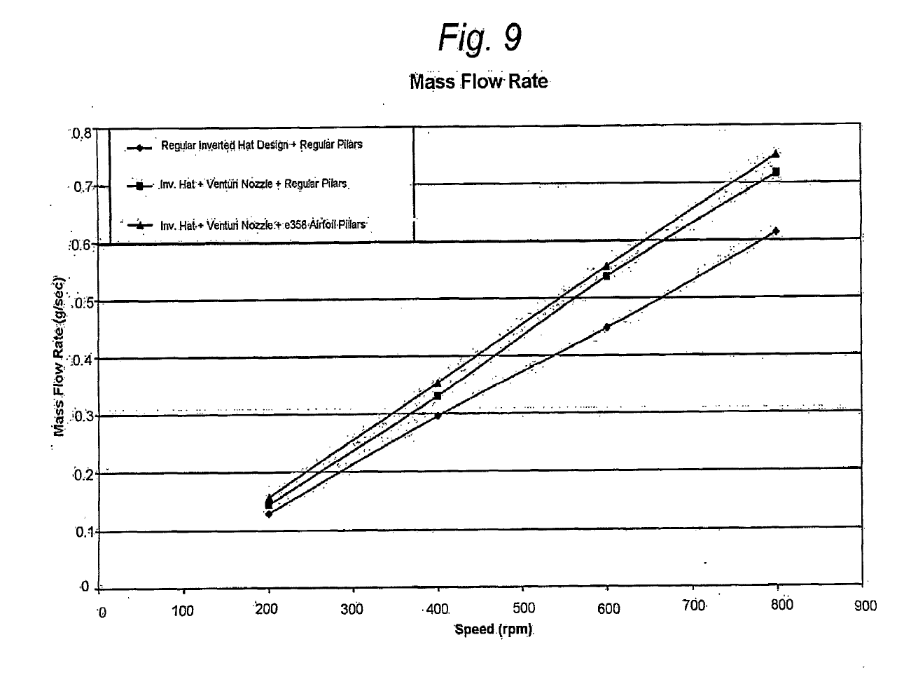

FIG. 9 is a graphical representation that is useful to illustrate the mass flow rate of the air flowing through the vented region in a brake disk rotor, the mass flow rate being an indicator of the air discharge. The figure further illustrates the amount of air being transferred through the same area, the higher the better, this figure additionally serving to compare the configurations of a conventional inverted hat brake disk rotor with conventional pillar design; a conventional inverted hat brake disk rotor with conventional pillars with venturi nozzles, and the inverted hat with airfoil-shaped pillars and a venturi nozzle. It is seen from this figure that the inventive design is able to draw more air through the vents due to the pressure differentials created by the configuration.

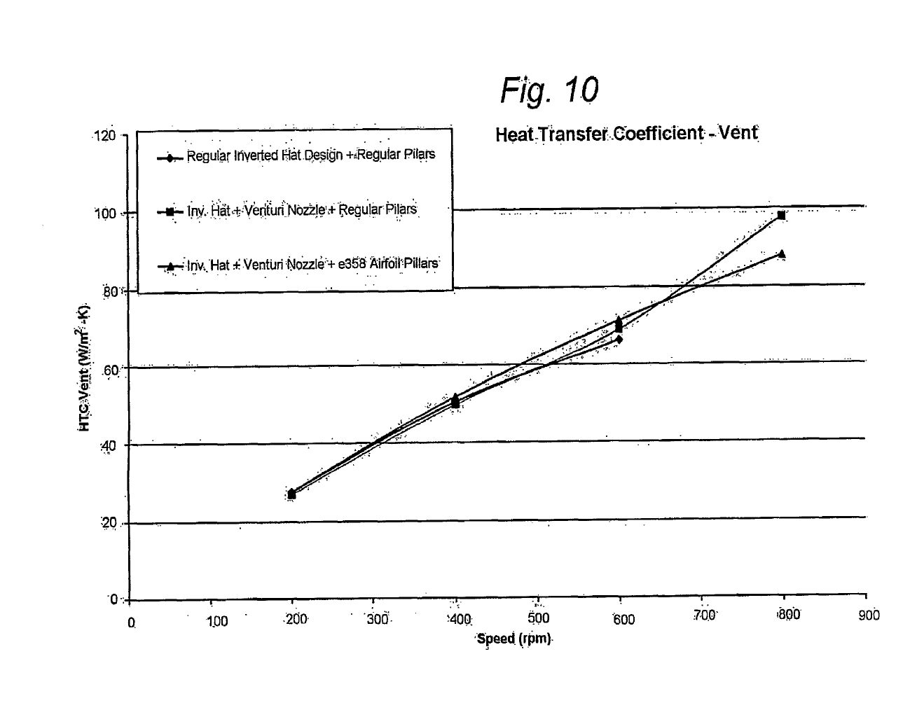

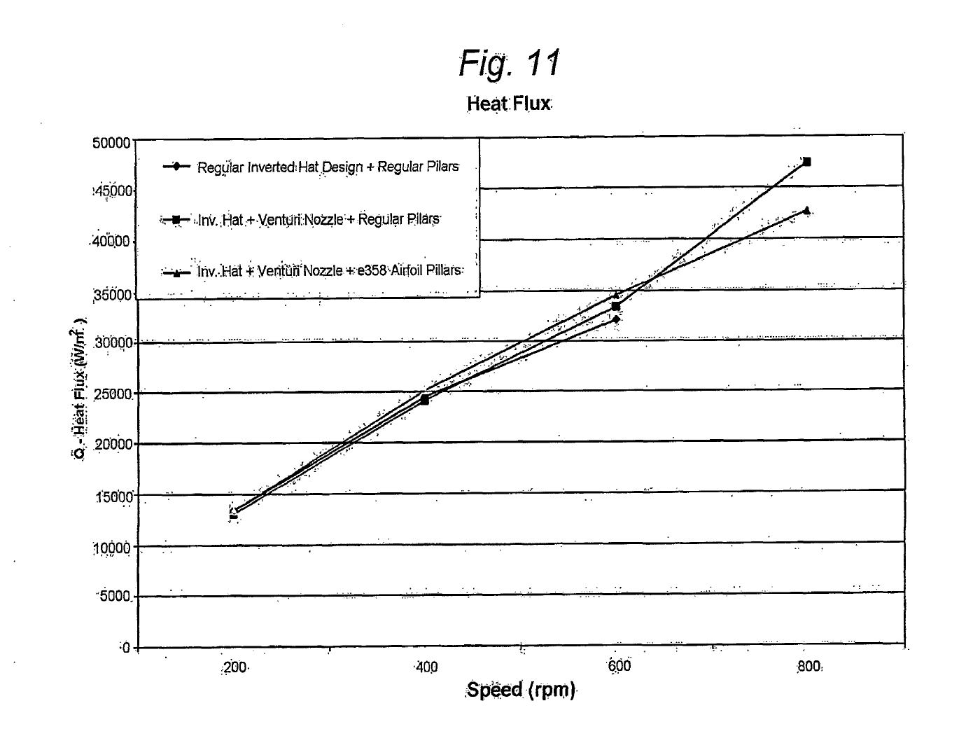

FIG. 10 is a graphical representation that is useful to illustrate essentially the same information as the heat transfer coefficient graph of FIG. 11, below.

FIG. 11 is a graphical representation that is useful to illustrate the comparison for the heat transfer coefficient, which is the most important characteristic, since it determines the convective cooling capacity of the brake disk rotor. The figure shows how quickly a brake disk rotor is able to dissipate the heat, and obviously the faster the better. An improvement in this characteristic is achieved with the usage of the airfoil-shaped pillars and the venturi nozzle configurations, and is more pronounced at higher speeds.

FIG. 11 is a graphical representation that is useful to illustrate the comparison for the heat transfer coefficient, which is the most significant characteristic, since it determines the convective cooling capacity of the brake disk rotor. The figure illustrates a comparison between the configurations of a conventional inverted hat brake disk rotor with conventional pillar design; a conventional inverted hat brake disk rotor with conventional pillars with venturi nozzles, and the inverted hat brake disk rotor with airfoil-shaped pillars and a venturi nozzle.

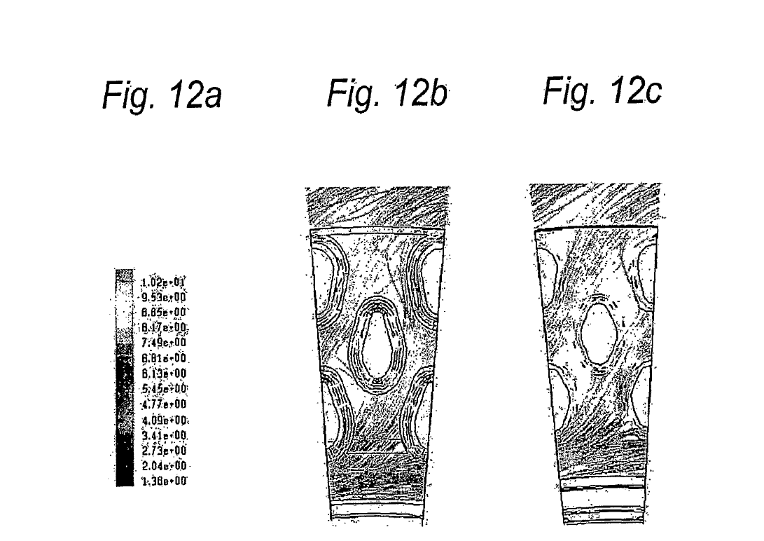

FIGS. 12a, 12b, and 12b are illustrations that are useful in describing the flow of air within the core of a brake disk rotor (not specifically designated) having airfoil-shaped pillars configured in accordance with the invention as compared to conventional pillars. More specifically, FIG. 12a represents a gradient of gray coloration used in FIGS. 12b and 12c to represent airflow, the gray coloration being compared to a numerical scale of airflow rate. The airflow rates represented in these figures are obtained at a disk rotation rate of 600 rpm.

FIG. 12b illustrates air flow within a brake disk rotor core having airfoil-shaped pillars. It is seen that at 600 rpm the air proceeds radially outward of the rotor and flows around both sides of the airfoil-shaped pillars. In FIG. 12c, the flow of air is represented in relation to diamond-shaped pillars. It is seen in FIG. 12c that portions of the regions surrounding the diamond-shaped pillars are subjected to almost no airflow at all. This results in a reduction of overall quantum of air being urged through the core of a disk brake,

Although the invention has been described in terms of specific embodiments and applications, persons skilled in the art may, in light of this teaching, generate additional embodiments without exceeding the scope or departing from the spirit of the invention described herein. Accordingly, it is to be understood that the drawing and description in this disclosure are proffered to facilitate comprehension of the invention, and should not be construed to limit the scope thereof.

1-20. (canceled)

21. A brake disk rotor arrangement for the brake system of a vehicle, the brake disk rotor arrangement having an annular configuration and a radius, the brake disk rotor arrangement comprising:
first and second brake disk rotor plates arranged substantially in parallel, with an annular ventilated region therebetween; and
an airfoil-shaped structure arranged in the annular ventilated region, said airfoil-shaped structure being configured as an airfoil-shaped fin;
wherein said first and second brake disk rotor plates have an annular central region therebetween that has a reduced axial distance to create an annular venturi effect in a radial airflow, said first and second brake disk rotor plates being cross-sectionally configured in combination with said airfoil-shaped fin to produce an effective venturi nozzle.

22. The brake disk rotor arrangement of claim 21, wherein said airfoil-shaped structure has an elongated configuration with a major axis aligned substantially radially in relation to the radius of the brake disk rotor arrangement.

23. The brake disk rotor arrangement of claim 21, wherein said airfoil-shaped structure is coupled at a first portion thereof to said first brake disk rotor plate, and at a second portion thereof to said second brake disk rotor plate.

24. The brake disk rotor arrangement of claim 23, wherein said airfoil-shaped structure comprises a structural element that maintains said first and second brake disk rotor plates in fixed spatial relation.

25. The brake disk rotor arrangement of claim 21, wherein said first and second brake disk rotor plates and said airfoil-shaped structure are integrally formed.

26. The brake disk rotor arrangement of claim 25, wherein said first and second brake disk rotor plates and said airfoil-shaped structure are integrally formed.

27. The brake disk rotor arrangement of claim 26, wherein there are provided a plurality of airfoil-shaped pillars arranged in an annular row of airfoil-shaped pillars.

28. The brake disk rotor arrangement of claim 27, wherein there are provided a plurality of annular rows of airfoil-shaped pillars.

29. The brake disk rotor arrangement of claim 28, wherein said plurality of annular rows of airfoil-shaped pillars, in combination with said first and second brake disk rotor plates, form a corresponding plurality of effective venturi nozzles.

30. The brake disk rotor arrangement of claim 28, wherein there is further provided a plurality of airfoil-shaped fins arranged intermediate of the plurality of annular rows of airfoil-shaped pillars.

31. A brake disk rotor arrangement for the brake system of a vehicle, the brake disk rotor arrangement comprising:
first and second brake disk rotor plates arranged substantially in parallel, with a ventilated region therebetween, said first and second brake disk rotor plates having an annular central region therebetween that has a reduced axial distance to create an annular venturi effect in a radial airflow; and
an aerodynamic structure arranged in the ventilated region.

32. The brake disk rotor arrangement of claim 31, wherein there is further provided a plurality of aerodynamic structures, the aerodynamic structures being configured in relation to one another to produce regions therebetween that produce a further venturi effect in the radial airflow.

33. The brake disk rotor arrangement of claim 32, wherein the annular venturi effect in a radial airflow and the further venturi effect in the radial airflow combine to increase the rate of heat removal from said first and second brake disk rotor plates.

34. A brake disk rotor arrangement for the brake system of a vehicle, the brake disk rotor arrangement having an annular configuration and a radius, the brake disk rotor arrangement comprising:
first and second brake disk rotor plates arranged substantially in parallel, with an annular ventilated region therebetween, the annular ventilated region having a variably configured axial distance to create an annular venturi that affects radial airflow; and
a plurality of airfoil-shaped structures arranged in the ventilated region that produce a further venturi effect in the radial airflow.

35. The brake disk rotor arrangement of claim 34, wherein said plurality of airfoil-shaped structures each have a substantially elongated configuration that is radially aligned with said first and second brake disk rotor plates.

36. The brake disk rotor of claim 35, wherein said plurality of airfoil-shaped structures are arranged in annular rows of airfoil-shaped structures.
